(19) United States
(12) Patent Application Publication
(10) Pub. No.: US 2017/0223922 A1
(43) Pub. Date: Aug. 10, 2017

(54) ICE CHEST AIRCONDITIONER FOR COOLING A PET OCCUPIED MOTOR VEHICLE

(71) Applicant: William Loopesko, Denver, CO (US)

(72) Inventor: William Loopesko, Denver, CO (US)

(21) Appl. No.: 15/428,833

(22) Filed: Feb. 9, 2017

Related U.S. Application Data
(60) Provisional application No. 62/293,157, filed on Feb. 9, 2016.

(51) Int. Cl. A01K 1/00; B60H 1/32; B60H 1/00; F25D 3/08; F25D 17/06

(52) U.S. Cl. CPC A01K 1/0082; F25D 3/08; F25D 17/06; B60H 1/00264; B60H 1/3235; B60H 1/00985; B60H 1/00657

(57) ABSTRACT

An ice chest air conditioner for cooling a pet in a stationary motor vehicle is provided. The air conditioner has an insulated ice chest reservoir. The reservoir contains a volume of ice. An insulated lid is a hollow double walled construction defining an interior cooling plenum and a separate exhaust duct. The cooling plenum has an air intake vent, and a cooled air exhaust vent, and a heat exchanger and fan assembly. A fan is operable to drawn in through the air intake vent, past the heat exchanger, and outwardly into an interior of the reservoir through the cooled air exhaust vent. Conditioned air from the reservoir is delivered into an interior of the motor vehicle through the air exhaust duct A fluid pump recirculates a volume of melting ice water through the heat exchanger. A snorkel is connected to the air exhaust duct for directing the conditioned air into an interior portion of the motor vehicle. A monitor and control is in operable power and control communication with the pump and fan assembly. A telemetry system includes a remotely controllable device with an application for control and display of system parameters.

### CROSS REFERENCE TO RELATED APPLICATIONS

This 35 U.S.C. §111(a) application claims the benefit of provisional application U.S. Ser. No. 62/293,157, filed Feb. 9, 2016.

### STATEMENT OF FEDERALLY SPONSORED RESEARCH

Not Applicable.

### BACKGROUND OF THE INVENTION

1. Field of the Invention

The present invention generally relates to air conditioning a pet occupied stationary motor vehicle. In particular, it relates to an ice chest air conditioner and wireless remote monitoring and control system for remotely protecting a pet from heat distress while occupying the interior of a motor vehicle when the owner is not present in the vehicle.

2. Description of the Related Art

High temperatures in a motor vehicle when the owner is not present are often a source of distress to the pets in a stationary motor vehicle without proper ventilation. To combat such heat and distress, and in an attempt to lower temperatures within stationary vehicles, many of the prior art devices include pet enclosures with aperture openings, such as a wire mesh window or door. These openings help to circulate the air flow through the interior of a motor vehicle, and allow for cooler air to enter.

One such example is found in U.S. Pat. No. 5,727,503 to Whittaker. There, a portable cooling kennel system for maintaining the temperature within a pets' kennel below a desired level is disclosed to allow the pet to travel. The kennel includes a typical kennel structure with a ventilation system, a sliding ice tray in a lower portion of the kennel, and at least one ice cartridge storage body for storing ice for cooling of the kennel.

While other prior art devices including pet kennels having fans, electro-mechanical devices, as well as other types of air conditioning units offer some utility, the kennels are expensive, complicated in construction, difficult in stowage, and complicated in design. The present invention overcomes these deficiencies.

### BRIEF SUMMARY OF THE INVENTION

It is therefore an object of the present invention to provide an ice chest air conditioner for cooling a pet when occupying the interior of a stationary motor vehicle.

It is another object of the present invention to provide a portable ice chest air conditioner for cooling a pet, while occupying the interior of a motor vehicle, together with an application being architecturally designed with logic operations so that a person is capable of remotely monitoring, controlling, displaying and alerting time, temperature, and system conditions calculated to relieve a pet from heat distress.

To overcome the problems of the prior art, and in accordance with the purpose of the invention, as embodied and broadly described herein, briefly an ice chest air conditioner for cooling a pet while occupied in a stationary motor vehicle is provided. The ice chest air conditioner has an insulated ice chest reservoir. The reservoir is adapted for containing a volume of ice melt in an interior portion thereof with a top opening adapted for loading a volume of ice into the interior of the reservoir. An insulated lid is in open and closable engagement with said top opening. The lid is a hollow double walled construction having top, bottom and sidewalls, said walls defining an interior cooling plenum and a conditioned air exhaust portion. The cooling plenum has an air intake vent in the lid top wall, an intake air exhaust vent in the lid bottom wall, and a heat exchanger and fan assembly. A fan of the assembly, is selectively operable to evacuate an interior portion of the reservoir so that a volume of ambient make-up air, to be cooled, is drawn in through the air intake vent in the lid top wall, past the heat exchanger and through the intake air exhaust vent in the lid bottom wall, and into the interior portion of the reservoir. The ambient air is thereby cooled to a conditioned air and the conditioned air is forced outwardly thorough the air exhaust portion. A fluid pump is disposed in the interior of the reservoir. The pump is in fluid communication with the heat exchanger for recirculating a volume of melting ice water through the heat exchanger. A snorkel has a nozzle end and an duct end. The duct end is pivotally attached to the lid in fluid communication with the conditioned air exhaust portion. The nozzle end is capable of directing the conditioned air into an interior portion of the motor vehicle. A monitor and control module has a power supply, a temperature monitor and control circuitry, and a temperature display. The power and control module is in operable control communication with the pump and fan assembly.

### BRIEF DESCRIPTION OF THE SEVERAL VIEWS OF THE DRAWINGS

The accompanying drawings, which are incorporated in and which constitute a part of the specification, illustrate at least one embodiment of the invention and, together with the description, explain the principles of the invention through illustration to persons of skill in the art.

FIG. 1 is an isometric view of the present invention showing a preferred location for the power supply, control module, and a remote control.

FIG. 2 is an isometric illustration showing the ice chest air conditioner when positioned in a motor vehicle so that the snorkel directs conditioned air back into the storage area of the vehicle.

FIG. 3 is an illustration showing the ice chest air conditioner, in a lid open position, showing the cooling air plenum cooled air exhaust vent, exhaust duct air vent, and the ice melt pump with supply and return lines for circulating cold water through the heat exchanger.

FIG. 4 is a side sectional view showing the relative positions of the cooling air intake plenum and exhaust duct.

FIG. 5 is schematic sectional view of the heat exchanger and fan assembly.

FIG. 6 is a block diagram showing the temperature sensor and control circuitry component of the temperature sensing and unit status monitoring telemetry system with a wireless transmission to the mobile device with application algorithm for determining and displaying a measured ambient temperature of the interior of a motor vehicle.

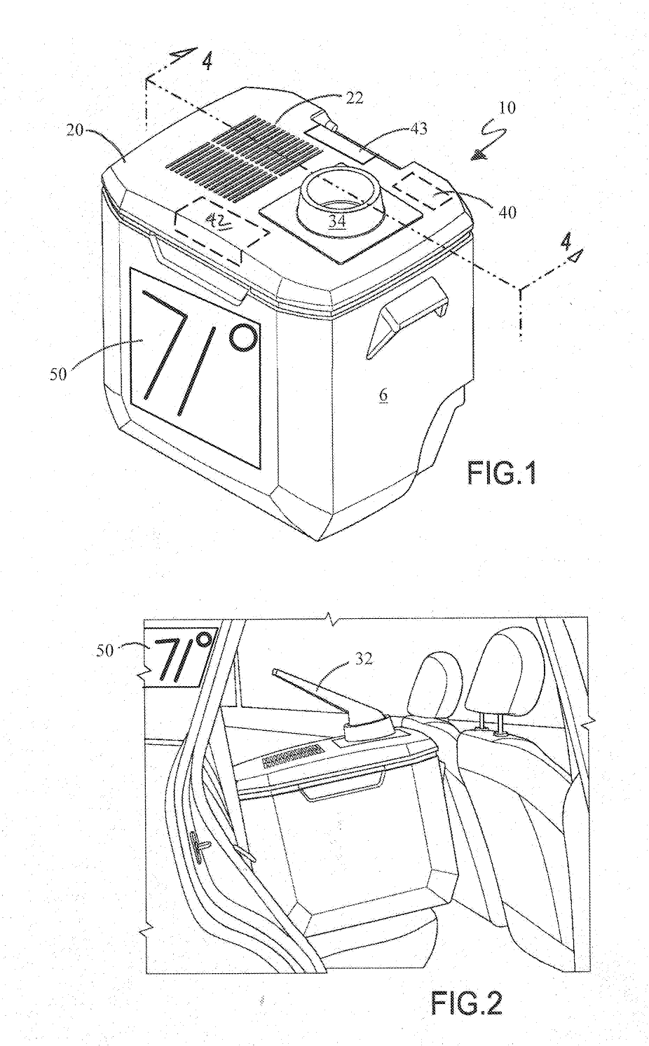

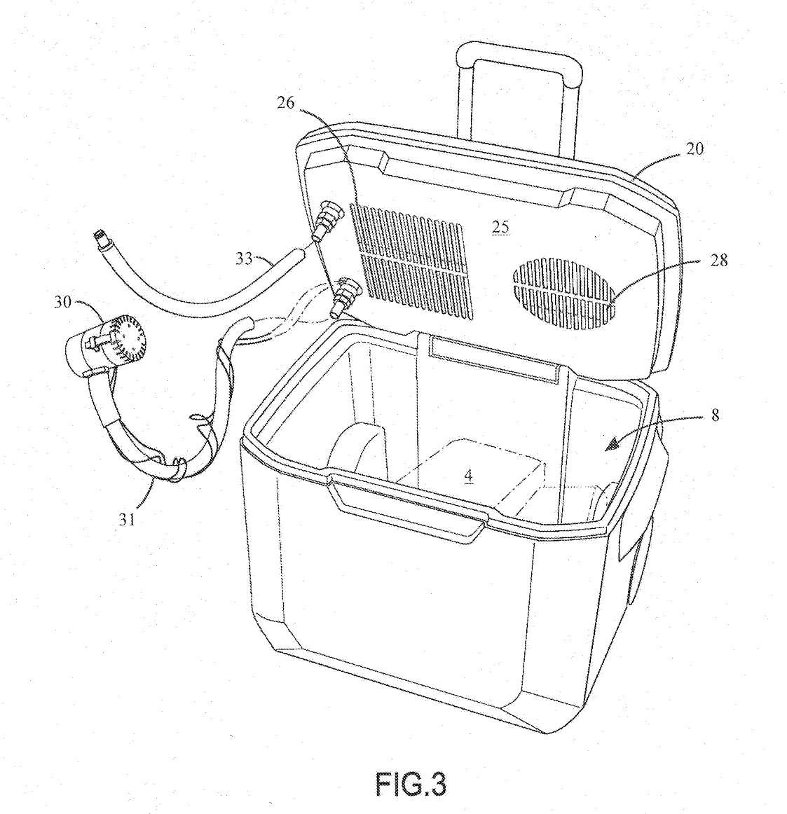

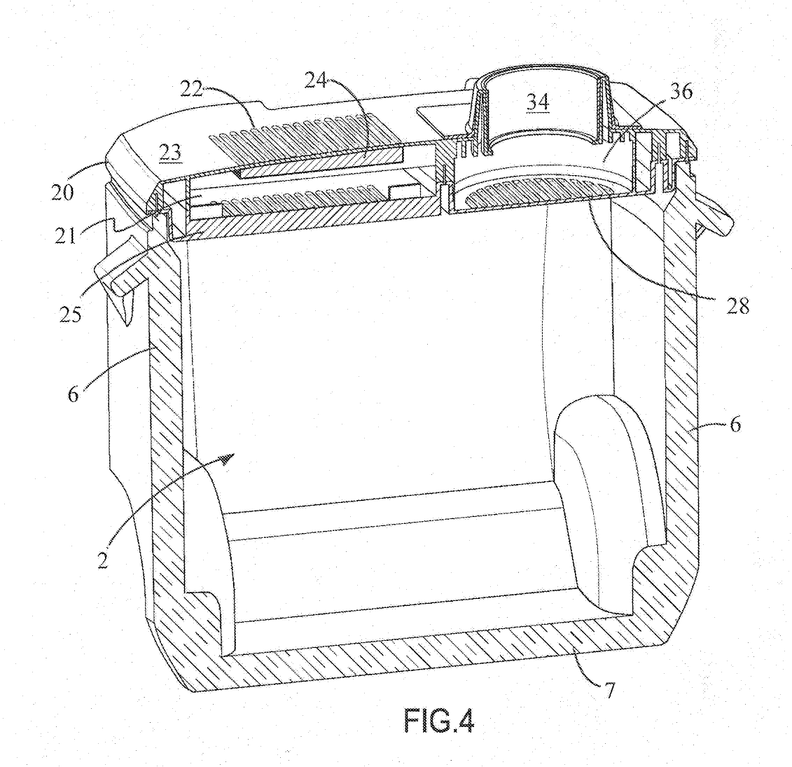

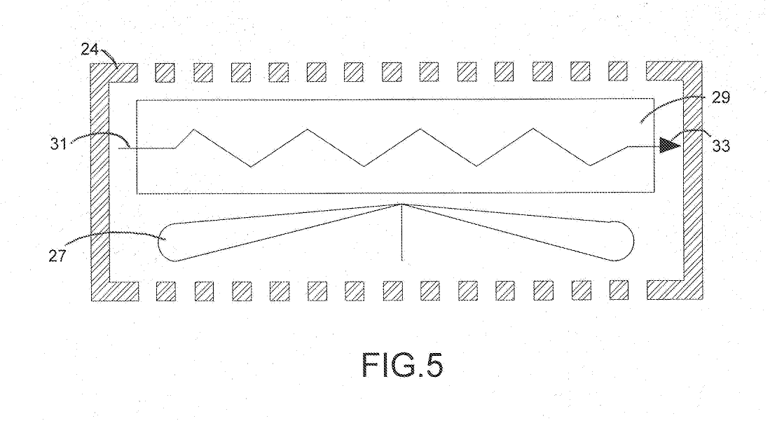

### DETAILED DESCRIPTION OF THE PREFERRED EMBODIMENTS

Unless specifically defined otherwise, all scientific and technical terms, used herein, have the same ordinary meaning as would be commonly understood by one of ordinary skill in the art to which this invention belongs.

Although any methods and materials similar or equivalent to those described herein, can be used in the practice or testing of the present invention, the preferred methods and materials are now described. Reference will now be made in detail, to the currently preferred embodiments of the invention, including the examples of which are illustrated in the accompanying drawings. In the drawings, like numerals will be used in order to represent like features of the present invention.

The present invention provides an ice chest air conditioner 10 for cooling a pet while occupying the interior of a motor vehicle. The present invention is contemplated for use when the vehicle is otherwise unoccupied. The ice chest air conditioner 10 has an insulated ice chest reservoir 2. The reservoir 2 is constructed of any type well know and is desirably constructed of a molded polymer construction having inner and outer walls with an insulating airspace, therebetween. The ice chest 10 is adapted for containing a volume of ice 4 and the ice melt cooling water. The reservoir 2 has four side walls 6, a bottom wall 7 and a top opening 8. The top opening 8 is adapted for loading a volume of ice 4 into the reservoir 2. An ambient makeup air vent 22 is in fluid communication with an interior of the reservoir 2. Ambient makeup air may be supplied as the ambient air of the interior space of the motor vehicle, to be conditioned, or it may be supplied via a duct, or hose, extending to the outside of the vehicle (not shown), such as a hose positioned through a window opening.

An insulated lid 20 is provided. The lid 20 is desirably of a double walled insulated closed wall polymer construction formed using any method well known in the art such as with rotational, or injection molding. The lid 20 has an interior ambient air cooling plenum 21 between a top wall 23 and a bottom wall 25 of the double wall polymer lid 20 construction. The lid 20 is formed to be in open and closable tight sealed fitment with the top opening 8. In this manner interior ambient air enters the reservoir through the cooling plenum 21. The ambient air cooling plenum 21 receives ambient air, from the interior of the motor vehicle, through an upper rectangular air vent 22 positioned in the top wall 23 of the lid 20. The lower wall of the lid 20 has a lower rectangular cooled air exhaust vent 26 which delivers ambient conditioned air directly from the cooling plenum 21 into the interior of the reservoir 2 for enhanced cooling. The ventilating plenum 21 includes a housing 24. The housing 24 contains a ventilating fan 27 and heat exchanger 29 assemblies.

The ventilating fan 27 is desirably a 12 v motor driven bladed fan 27, of any type which is well known in the art, and is operable to evacuate the sealed interior portion of the reservoir 2 in order to draw the ambient airflow directly through the upper rectangular air vent 22, through the heat exchanger 29, and forcefully out of the cooling plenum 21 and into the interior of the reservoir 2 through the lower cooled air exhaust vent 26. In this manner, the ambient air is first cooled first as it passes in contact with the heat exchanger 29 and then conditioned again as it circulates throughout the ice 4 containing interior of the reservoir 2.

A pump 30, such as a vane apparatus, is disposed in the interior of the reservoir 2 adjacent to the bottom wall 7. The pump 30 delivers melted ice water to the heat exchanger 29 via an ice melt supply hose 31. The pump 30 is in fluid communication with the heat exchanger 29 A drain hose 33 returns the ice melt water from the heat exchanger 29, back into the interior of the reservoir 2.

In the presently preferred embodiment, a conditioned air exhaust duct 36 has a lower conditioned air intake vent 28 and an upper collar 34. The collar 34 is formed in the top wall 23. An air directional snorkel 32 is pivotally attached to collar 34. In another embodiment, the conditioned air exhaust duct 36, vent 28, and collar 34 maybe formed in any one of the side walls 6 of the reservoir 2.

The snorkel 32 is desirably a hollow rigid walled cone shaped member having a central conditioned airflow exhaust tube with a nozzle end, and a duct end. The snorkel 32 is in ducted communication with the interior of the reservoir 2. The duct end of the snorkel 32 is pivotally attached to the collar 34 for blowing the conditioned air in a predetermined direction being in close proximity to the pet to be cooled.

A temperature monitor and power control module 40 includes a power supply 42, a temperature monitor and power control circuitry, and a temperature display 50. The module 40 is desirably housed in the lid 20. The power and control module 40 is in operable controlled communication with the pump 30 and fan 27. In this manner, the ice chest air conditioner 10 may, but need not, be thermostatically controlled using a range of predetermined set points. The large visible temperature display 50 may, but need not, be attachable to an exterior surface of the air conditioner 10, or, to a side window of the pet occupied motor vehicle.

The present invention is desirably powered with a rechargeable battery 42. One or more power supplies may also be provided. In the presently preferred embodiment, the battery 42 is rechargeable using a standard 12 Volt vehicle outlet, a USB port, or any other power source which is well known, and is desirably removable from the control module 40 for recharging with a remotely located alternating-current power supply. The present invention may also, but need not, be directly powered using a direct cable connection established between the control module 40 and any standard 12 volt vehicle outlet, which is well known. The power supply 42 is of sufficient capability to power the blower fan 27, fluid pump 30, control module 40 micro-circuitry, temperature display 50, and to transmit monitoring and control real time data wirelessly for remote monitoring and control of the ice chest air conditioner.

The control module 40 desirably houses all of the electronic and control circuits including, temperature sensors, logic circuits, timers, memories, processors, and output displays showing real time monitoring information relating to, temperature, time, system, and set-point information. At least one temperature sensor may, but need not, be desirably attached to a collar of the animal, to be cooled. The monitoring and display circuitry is operable to display real time temperature data of the vehicle, and the animal for ease in observation by passersby so that such persons are capable of knowing that the animal is safely confined within the vehicle. As above, the temperature display 50 is desirably positioned on a car window, but may be positioned on the top wall of the lid control unit so that it is visible through the window opening of the vehicle interior to be conditioned.

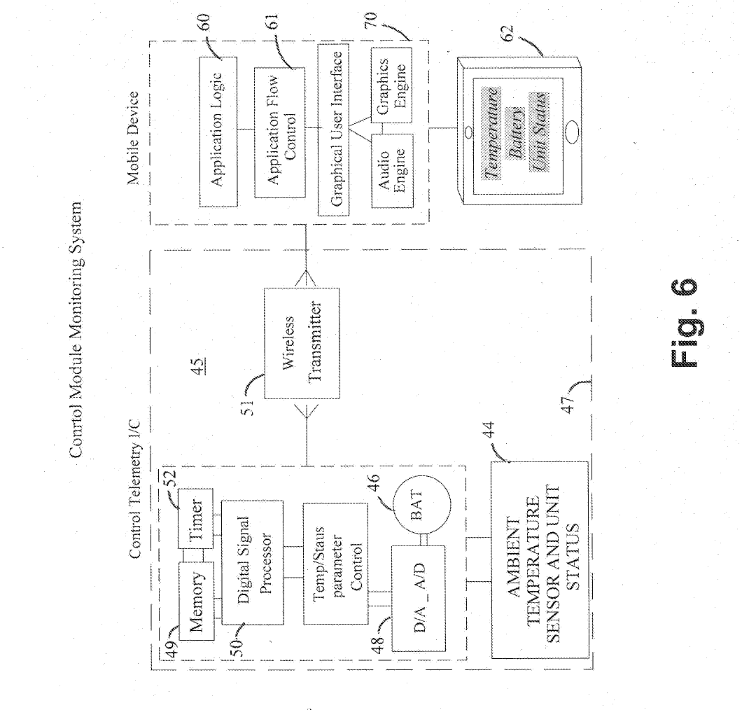

Referring now to FIG. 6, in yet another preferred embodiment of the present invention, the control module 40 includes a temperature sensor and unit control monitoring system. As shown in the drawing figure, the system may, but need not, also include a temperature and unit control telemetry system which, when housed in the lid 20, includes any combination of input and output data including information relating to time, temperature, airflow, battery charge, sensor, pump, and fan performance 44, coupled with a single IC Chip 45 having an electronic circuit 47, a memory 49, a Digital-to-Analog/Analog-to-Digital converters 48, a programmable Digital Signal Processor 50, a wireless transmitter 51, timers, filters, and power source such as 12 V DC motor vehicle power supply or battery 46 for transmission of the wireless output. A mobile device application 60, or computer, such as a mobile phone 70, then receives data wirelessly, does the analysis according to a preprogrammed algorithm 61, and displays 62 a vehicle interior ambient temperature and operating unit status in real time together with an application input to adjust the ambient temperature remotely in order to optimize comfort and safety of the animal to be cooled.

The Application 60 is provided for programming the external wireless device. The Application 60 includes logic elements capable of using transmitted information to monitor, determine output, display, transmit, and control the control unit's monitoring and control elements remotely using the external wireless device. For example, the Application 60 includes programmable logic sequences to power, monitor, control, and display any one of the interior temperature of the motor vehicle, a temperature statistic related to an interior of the vehicle occupied by the animal, an image, battery charge condition, cooling fluid level, and pump operation, in real-time. The Application 60 is also capable of determining a failed condition using the monitoring circuit information and outputting a failed condition alarm by tone, vibration or with visible display indicia. For example, under overheating conditions, low battery charge, or low cooling fluid volume, the remote monitoring processor receives data reflecting the condition, stores data, compares data with predetermined set-point data, determines a failed condition, and outputs an alert signal which is operable using the remote device to transmit correcting control information to the monitoring and control circuitry of the air-conditioning control unit.

Additional advantages of the present invention will be set forth in the description that follows, and in part will be obvious from that description or can be learned or appreciated from practice of the invention. Moreover, the advantages of the invention can be realized and obtained by the invention as more particularly pointed out in the appended claims.

1. An ice chest air conditioner for cooling a pet while occupied in a motor vehicle, comprising:
(a) an insulated ice chest reservoir adapted for containing a volume of ice melt in an interior portion thereof, said reservoir having four side walls, a bottom wall and a top opening, said top opening adapted for loading said volume of ice into said interior portion of said reservoir;
(b) an insulated lid adapted for tight fitment in sealed closable engagement with said top opening, said lid being of a hollow double walled construction having a top, a bottom and sidewalls, said walls defining a first interior cooling plenum and a second conditioned air exhaust duct, said cooling plenum having an upper ambient air intake vent in the lid top wall, a lower cooled ambient air exhaust vent in the lid bottom wall, and a heat exchanger and fan assembly, whereby a said fan of said assembly, is selectively operable to evacuate an interior portion of said cooling plenum so that a volume of said ambient air is drawn into said cooling plenum through said ambient air intake vent in contact with said heat exchanger, and the forcefully exhausted from said cooling plenum through said lower cooled ambient air exhaust vent into said interior portion of said reservoir where a conditioned air is forced outwardly though said conditioned air exhaust duct;
(c) a fluid pump, disposed in said interior of said reservoir, being in fluid communication with said heat exchanger, for recirculating a volume of melting ice water through said heat exchanger;
(d) a snorkel having a nozzle end and an duct end, said duct end being pivotally attached to said lid in fluid communication with said conditioned air exhaust duct, and said nozzle end being capable of directing said conditioned air into an interior portion of said motor vehicle; and
(e) a monitor and control module including a power supply, and a temperature monitor and control circuitry, wherein said power and control module being in operable control communication with said pump and fan assembly.

2. The ice chest air conditioner, according to claim 1 further comprising a real-time temperature display visibly attached to a window of the motor vehicle to be occupied.

3. The ice chest air conditioner, according to claim 1 further comprising a real-time temperature display visibly attached to a surface of the reservoir.

4. The ice chest air conditioner, according to claim 1, wherein the monitor and control module further comprises, a telemetry system, and an external wireless monitoring control and display device.

5. The ice chest air conditioner, according to claim 4, wherein the device is a phone.

6. The ice chest air conditioner, according to claim 4, wherein the remote monitoring control and display device further includes an application downloadable to said wireless remote device, said application being pre-programmed with logic operations being architecturally predesigned to monitor, control and display real-time temperature, system, and image information.
